(19) United States
(12) Patent Application Publication
(10) Pub. No.: US 2006/0080392 A1
(43) Pub. Date: Apr. 13, 2006

(54) Server system, message communication method, and program

(75) Inventors: Nobuo Kawakami, Tokyo (JP); Daiki Sato, Tokyo (JP)

Correspondence Address: GREENBLUM & BERNSTEIN, P.L.C., 1950 ROLAND CLARKE PLACE, RESTON, VA, 20191, US

(73) Assignee: DWANGO CO., LTD., Tokyo (JP)

(21) Appl. No.: 10/950,462

(22) Filed: Sep. 28, 2004

(30) Foreign Application Priority Data
Jan. 22, 2004 (JP) 2004-014878

(51) Int. Cl. G06F 15/16

(52) U.S. Cl. 709/206

(57) ABSTRACT

A message can be efficiently communicated by using a location accessed, in a virtual world embodied in a network by a portable terminal such as a mobile phone, as a trigger. By recording a message which is desired to be sent to a friend registered in a message record table of a database corresponding to a web server URL, the recorded message is distributed to the portable terminal of the friend when the friend accesses the web server using his/her own portable terminal. Thereby, a user can receive a message from a friend who knows his/her favorite music genre or artist when the user wants to download a melody and visits a melody distribution site.

The present invention relates to subject matter contained in Japanese Patent Application No. 2004-14878, filed on Jan. 22, 2004 the disclosure of which is expressly incorporated herein by reference in its entirety.

### BACKGROUND OF THE INVENTION

1. Field of the Invention

The present invention relates to a server system, a message communication method, and a program, in which message communications from a portable terminal, such as a mobile phone, is performed through a network such as the Internet.

2. Description of the Related Art

Conventionally, in order to communicate a message between portable terminals such as mobile phones, a mail system is mainly used. In addition to mail, there exists a system for notifying a concerned party of a message. For example, NTT Docomo's i-shot® system sends a message notification to a mobile phone number.

The above-mentioned system has a configuration of transmitting the message to the receiving party upon transmitting the message and thus is matched to the needs for notifying the concerned party in a real time.

There also exists a system which receives a message and sends a notification to the portable terminal of a concerned party when the portable terminal is located in a specific location (see Japanese Patent No. JP-A-8-126062). In this case, the message arrives according to the physical location of the portable terminal of the concerned party.

Currently, various kinds of services can be enjoyed using the Internet even with a mobile phone. For example, a service exists for reading web pages provided by a web server connected to the Internet through a mobile network, and for receiving recent information such as music, news and weather forecasts, and downloading contents to a mobile phone, such as a ring melody.

Nowadays, since it is possible to freely come and go in the virtual world with a portable terminal, similar to receiving a message by using, as a trigger, the case that the portable terminal is physically moved to a predetermined location as in the above-mentioned conventional example, the configuration of efficiently receiving messages for delivering the location accessed in a virtual world of the mobile phone as the trigger is expected.

### SUMMARY OF THE INVENTION

An object of the present invention is to provide a server system, a message communication method and a program, in which a message can be efficiently communicated by using the location of the portable terminal in the virtual world, embodied in the network, as the trigger.

One aspect of the present invention is directed to a server system for communicating with a portable terminal through a network. The server system includes a message storage for storing a message and address information and associating the message with the address information, and a determiner for determining whether or not a message associated with the address information exists in the message storage when a portable terminal accesses the address information. The system also includes a message transmitter for transmitting the message to the portable terminal if it is determined by the determiner that a message is present.

In another embodiment the server system includes a page storage for storing page information and address information and associating the page information with the address information in the network, and a message storage for storing a message and address information and associating the message with the address information in the network. The server system also includes a page transmitter for reading out the page information associated with the address information from the page storage and transmitting a page image based on the read out page information to the portable terminal, when the portable terminal accesses the address information stored in the page storage through the network. The server system also includes a determiner for determining whether or not the address information is associated with a message in the message storage when the portable terminal accesses the address information, and a message transmitter for transmitting the associated message to the portable terminal. The address information is uniform resource locator (URL) information.

In another embodiment, the server system includes a page storage for storing page information and address information and associating the page information with the address information in the network, and a message storage for storing a message and address information and associating the message with the address information in the network. The server system also includes a page transmitter for reading out the page information associated with the address information from the page storage and transmitting a page image based on the read out page information to the portable terminal when the portable terminal accesses the address information stored in the page storage through the network. The server system also includes a determiner for determining whether or not the address information is associated with a message in the message storage when the portable terminal accesses the address information, and a message transmitter for transmitting the associated message to the portable terminal. The message transmitter allows the message to be displayed on the portable terminal.

In another embodiment, the server system includes a page storage for storing page information and address information and associating the page information with the address information in the network, and a message storage for storing a message and address information and associating the message with the address information in the network. The server system also includes a page transmitter for reading out the page information associated with the address information from the page storage and transmitting a page image based on the read out page information to the portable terminal when the portable terminal accesses the address information stored in the page storage through the network. The server system also includes a determiner for determining whether or not the address information is associated with a message in the message storage when the portable terminal accesses the address information; and a message transmitter for transmitting the associated message to the portable terminal. The message transmitter transmits the message to the portable terminal in the form of mail.

In another embodiment, server system further includes a member storage for storing member information such as a mail address and corresponding portable terminal identification information, and a member determiner for determining whether or not the portable terminal is a member based on the portable terminal identification information, by referring to the member storage. The message transmitter reads out the mail address of the member from the member storage and transmits the message to the read out mail address in the form of mail if it is determined by the member determiner that the portable terminal is a member.

In another embodiment, the server system includes a page storage for storing page information and address information and associating the page information with the address information in the network, and a message storage for storing a message and address information and associating the message with the address information in the network. The server system also includes a page transmitter for reading out the page information associated with the address information from the page storage and transmitting a page image based on the read out page information to the portable terminal when the portable terminal accesses the address information stored in the page storage through the network. The server system also includes a determiner for determining whether or not the address information is associated with a message in the message storage when the portable terminal accesses the address information, and a message transmitter for transmitting the associated message to the portable terminal. The server system further includes a register for registering the message stored in the message storage and identification information of the portable terminal which receives the message in the message storage so that the message corresponds to the identification information, in response to the portable terminal accessing the address information. In another embodiment, the register further registers the message correspondingly to the address information.

Another aspect of the present invention relates to a message communication method for communicating with a portable terminal through a network. The method includes storing a message and an address information in memory, associating the message with the address information in the memory, and determining whether or not a message associated with the address information is present in the memory when a portable terminal accesses the address information. The method also includes transmitting the message to the portable terminal if it is determined that a message is present.

In another embodiment, the message communication method includes storing page information and address information in memory, associating the page information with the address information in the memory, storing a message and an address information in memory, and associating the message with the address information in the memory. The method also includes reading out a page information associated with an address information from the memory and transmitting a page image based on the read out page information to a portable terminal when the portable terminal accesses the address information stored in memory, and determining whether or not the address information is associated with a message in the memory when the portable terminal accesses the address information. The method also includes transmitting the associated message to the portable terminal. The address information is a uniform resource locator (URL) information.

In another embodiment, the message communication method includes storing page information and address information in memory, associating the page information with the address information in the memory, storing a message and an address information in memory, and associating the message with the address information in the memory. The method also includes reading out a page information associated with an address information from the memory and transmitting a page image based on the read out page information to a portable terminal when the portable terminal accesses the address information stored in memory, and determining whether or not the address information is associated with a message in the memory when the portable terminal accesses the address information. The method also includes transmitting the associated message to the portable terminal. The message is displayed on the portable terminal when it accesses the address information.

In another embodiment, the method includes storing page information and address information in memory, associating the page information with the address information in the memory, storing a message and an address information in memory, and associating the message with the address information in the memory. The method also includes reading out a page information associated with an address information from the memory and transmitting a page image based on the read out page information to a portable terminal when the portable terminal accesses the address information stored in memory, and determining whether or not the address information is associated with a message in the memory when the portable terminal accesses the address information. The method also includes transmitting the associated message to the portable terminal. The message is transmitted to the portable terminal in the form of mail.

In another the embodiment, the message communication method further includes storing member information such as a mail address and corresponding portable terminal identification information in memory, and determining whether or not the portable terminal is a member based on identification information of the portable terminal, by referring to the memory. Transmitting the message includes reading a mail address of the member from the memory and transmitting the message to the read mail address in the form of mail, if it is determined that the portable terminal corresponds to a member.

In another embodiment, the message communication method includes storing page information and address information in memory, associating the page information with the address information in the memory, storing a message and an address information in memory, and associating the message with the address information in the memory. The method also includes reading out a page information associated with an address information from the memory and transmitting a page image based on the read out page information to a portable terminal when the portable terminal accesses the address information stored in memory, and determining whether or not the address information is associated with a message in the memory when the portable terminal accesses the address information. The method also includes transmitting the associated message to the portable terminal, and registering the message stored in the memory and identification information of the portable terminal which receives the message so that the message corresponds to the identification information in response to the portable terminal accessing the address information. In another embodiment, the registering the message further includes registering the message corresponding to the address information.

Another aspect of the invention is directed to a program executed by a server for communicating with a portable terminal through a network. The program contains code which when executed by the server causes the server to perform operations including storing a message and an address information in memory, and associating the message with the address information in the memory. The operations also include determining whether or not a message associated with the address information is present in the memory when a portable terminal accesses the address information, and transmitting the message to the portable terminal if it is determined that a message is present.

In another embodiment, the program operations include storing page information and address information in memory, associating the page information with the address information in the memory, storing a message and an address information in memory, and associating the message with the address information in the memory. The operations also include reading out a page information associated with an address information from the memory and transmitting a page image based on the read out page information to a portable terminal when the portable terminal accesses the address information stored in memory, and determining whether or not the address information is associated with a message in the memory when the portable terminal accesses the address information. The operations also include transmitting the associated message to the portable terminal. The address information is a uniform resource locator (URL) information.

In another embodiment, the program operations include storing page information and address information in memory, associating the page information with the address information in the memory, storing a message and an address information in memory, and associating the message with the address information in the memory. The operations also include reading out a page information associated with an address information from the memory and transmitting a page image based on the readout page information to a portable terminal when the portable terminal accesses the address information stored in memory. The operations also include determining whether or not the address information is associated with a message in the memory when the portable terminal accesses the address information, and transmitting the associated message to the portable terminal. The message is displayed on the portable terminal when it accesses the address information.

In another embodiment, the program operations include storing page information and address information in memory, associating the page information with the address information in the memory, storing a message and an address information in memory, and associating the message with the address information in the memory. The operations also include reading out a page information associated with an address information from the memory and transmitting a page image based on the read out page information to a portable terminal when the portable terminal accesses the address information stored in memory. The operations also include determining whether or not the address information is associated with a message in the memory when the portable terminal accesses the address information, and transmitting the associated message to the portable terminal. The message is transmitted to the portable terminal in the form of mail.

In another embodiment, the program operations further include storing member information such as a mail address and corresponding portable terminal identification information in memory, and determining whether or not the portable terminal is a member based on identification information of the portable terminal by referring to the memory. Transmitting the message includes reading a mail address of the member from the memory and transmitting the message to the read mail address in the form of mail, if it is determined that the portable terminal corresponds to a member.

In another embodiment, the program operations include storing page information and address information in memory, associating the page information with the address information in the memory, storing a message and an address information in memory, and associating the message with the address information in the memory. The operations also include reading out a page information associated with an address information from the memory and transmitting a page image based on the read out page information to a portable terminal when the portable terminal accesses the address information stored in memory. The operations also include determining whether or not the address information is associated with a message in the memory when the portable terminal accesses the address information, transmitting the associated message to the portable terminal, and registering the message stored in the memory and identification information of the portable terminal which receives the message so that the message corresponds to the identification information, in response to the portable terminal accessing the address information. In another embodiment, registering the message further includes registering the message corresponding to the address information.

### BRIEF DESCRIPTION OF THE DRAWINGS

FIG. 1 is a schematic diagram showing a network system related to the present invention;

FIG. 2 is a block diagram showing an example of a web server system configuration related to the present invention;

FIG. 3A, FIG. 3B and FIG. 3C illustrates various kinds of record tables set in a database of the web server system related to the present invention;

FIG. 4 is a block diagram showing a configuration of an example of a mobile phone related to the present invention;

FIG. 5 is a flowchart for illustrating a member registration operation according to the present invention;

FIG. 6 is a flowchart for illustrating a message setting operation according to the present invention;

FIG. 7 illustrates display screen transitions of a mobile phone when setting a message according to the present invention;

FIG. 8 illustrates an example of a message display according to the present invention; and

FIG. 9 is a flowchart for illustrating a message acquisition operation according to the present invention.

### DESCRIPTION OF THE PREFERRED EMBODIMENT

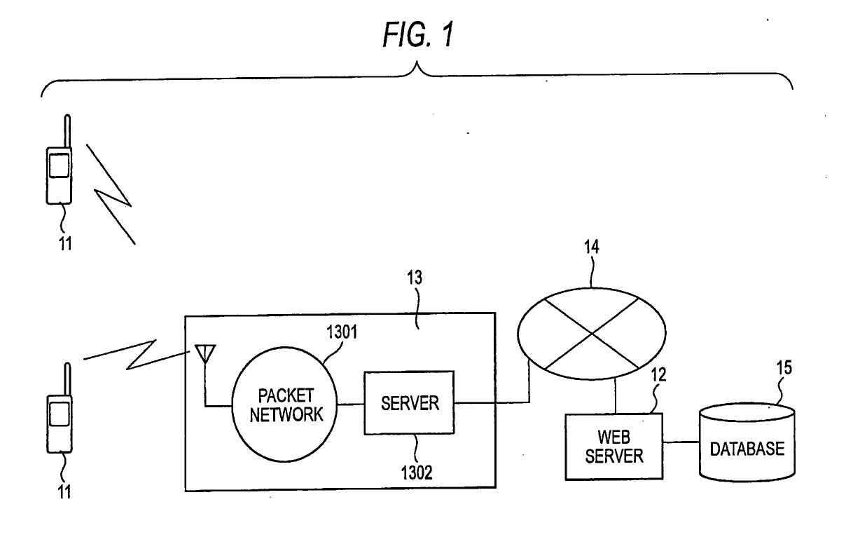

Hereinafter, a preferred embodiment according to the present invention will be described with reference to the appended drawings. First, the whole configuration thereof will be described. FIG. 1 is a schematic diagram showing a network system according to an embodiment of the present invention. In the network system shown in FIG. 1, a portable terminal 11, which in one example is a mobile phone, is communicatively connected with a web server 12 via a mobile network 13 and the Internet 14.

The portable terminal 11 shown in FIG. 1 has an Internet communication function. For Internet communication, HTTP (Hyper Text Transfer Protocol) may be used for transmitting and receiving data to and from the web server 12. The web server 12 is used as a site for distributing messages, which may comprise images and/or characters, according to a request from the portable terminal 11. Particularly, when distributing a message composed of images or characters between portable terminals, a database 15 is utilized. The detailed description thereof will be set forth below.

The mobile network 13 comprises a packet network 1301 for controlling packet communication with the portable terminals 11 and a server 1302 for controlling communication between the portable terminal 11 and the Internet 14. The Internet 14 performs (i.e., enables) communication with the portable terminal 11 through the mobile network as well as communications between a personal computer (not shown) and a server (not shown) connected to the same network. Hereinafter, the portable terminal 11 and the web server 12 will be described in detail.

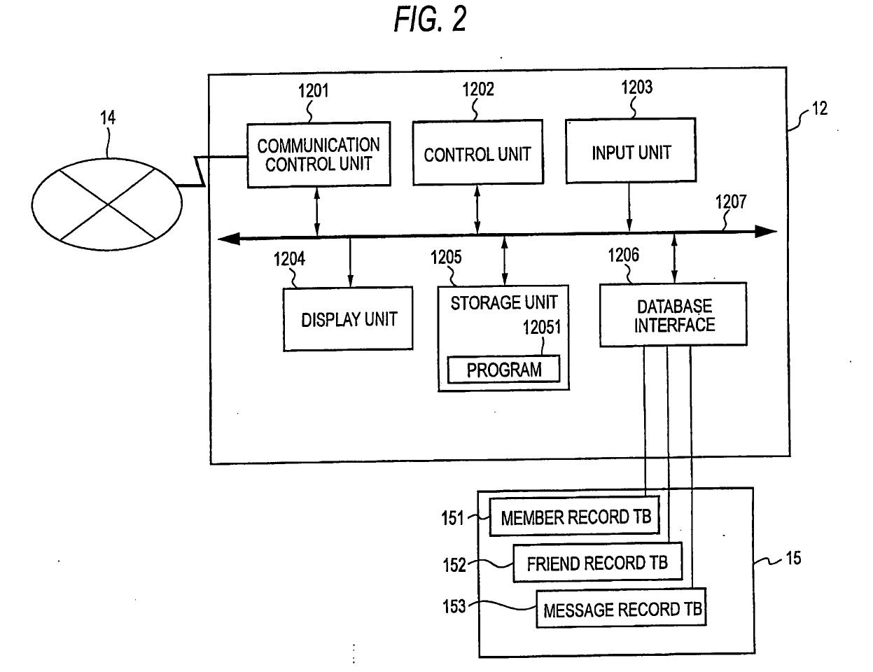

FIG. 2 is a block diagram showing the configuration of the web server 12. In FIG. 2, the web server 12 is connected to the Internet 14, and comprises a communication control unit 1201 responsible for bi-directional communication between different equipment such as a portable terminal 11 and a personal computer through the Internet 14, a control unit 1202 having a CPU, ROM, RAM and the like and responsible for overall control of the whole server, an input unit 1203 for sending various signals for operating the server to the control unit 1202, a display unit 1204, a storage unit 1205 having a storing region 12051 for storing a program, including an application program responsible for mail transmission/reception, a database interface 1206 for connecting the database 15 to the server, and a bus line 1207 providing bi-directional communication between each portion of the server. The control unit 1202 distributes messages, which may comprise images or characters, according to a request from other devices such as a portable terminal 11 through the Internet 14.

As shown in FIG. 2, the database 15 stores a member record table 151 for managing portable terminal users that are registered as members, a friend record table 152 for managing a friend list for each registered member, and a message record table 153 for managing messages input by registered members. Hereinafter, each of the above-mentioned tables will be described in detail.

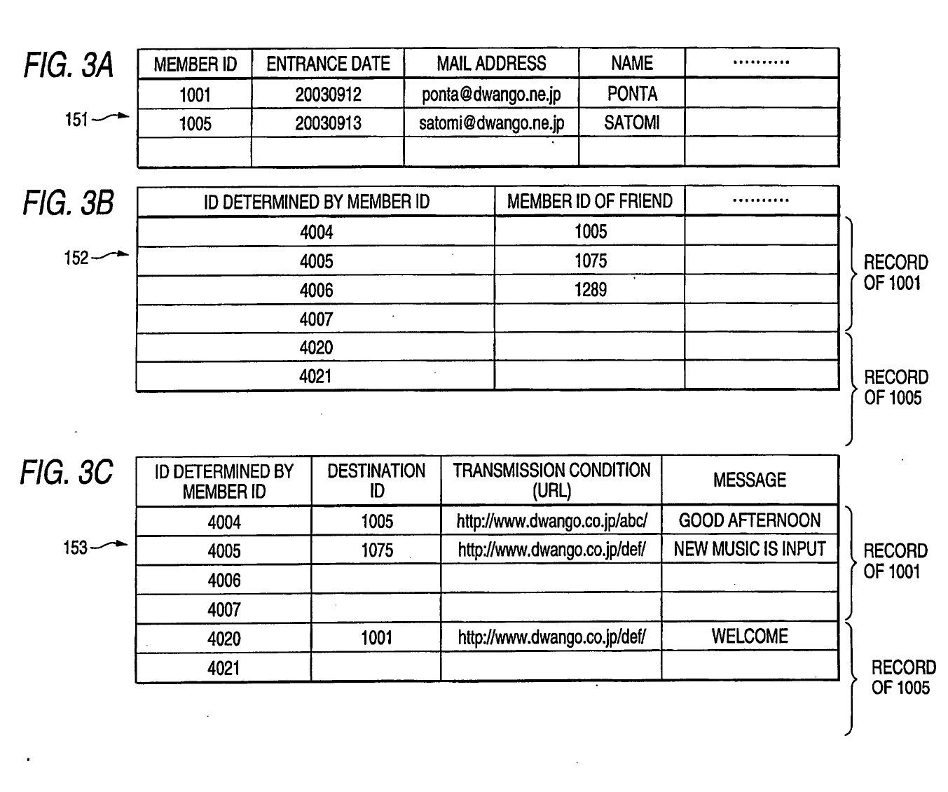

FIG. 3 shows the member record table 151, the friend record table 152 and the message record table 153. In the member record table 151 in FIG. 3A, member information such as ‘member ID’, ‘entrance date’ and ‘mail address’ is stored for every user that wants to register as a member. In this example, member information for two users is stored: the member information of the user having the member ID ‘1001’ comprises an entrance date of ‘2003.9.12’ and a mail address of ‘PONTA@dwango.ne.jp’, and the member information of the user having the member ID ‘1005’ comprises an entrance date of ‘2003.9.13’ and a mail address of ‘SATOMI@dwango.ne.jp’. When a user's membership is canceled, his member ID is deleted.

In the friend record table 152 in FIG. 3B, ‘IDs determined by member ID’, ‘member IDs of the friend’ and the like are stored. In one embodiment of the friend record table 152, each member may register up to four other members as friends. In other words, ‘Ponta’ which is the user having the member ID ‘1001’ has four records of ‘4004’, ‘4005’, ‘4006’ and ‘4007’, and ‘Satomi’ which is the user having the member ID ‘1005’ has four records of ‘4020’, ‘4021’, ‘4022’ and ‘4023’ (here, the records of ‘4022’ and ‘4023’ are not shown). In this way, the member ID of the friend can be registered in correspondence with each record. In this figure, the member ID of the friends registered by ‘Ponta’ are ‘1005’, ‘1075’, and ‘1289’. Also, ‘1005’ is ‘Satomi’ and is registered as a friend of ‘Ponta’.

In the message record table 153 in FIG. 3C, ‘IDs determined by member ID’, ‘destination ID’, ‘URL’, ‘message’ and the like are stored. In this figure, ‘Ponta’, which is the user having the member ID ‘1001’ is associated with a message of ‘Good afternoon’ from ‘Satomi’, who has the member ID ‘1005’. Here, when the ‘Ponta’ accesses ‘http://www.dwango.co.jp’, the message from ‘Satomi’ (that is, ‘Good afternoon (Satomi)’) is displayed on the homepage screen of ‘dwango.co.jp’. In addition, as mentioned below, the message may be transmitted by electronic mail or may be forwarded to an application of the portable terminal 11 to be delivered to the user of the portable terminal 11. Also, when ‘Ponta’ accesses the URL ‘http://www.dwango.co.jp’, the message ‘new music is input’ from the user (termed as ‘ton’), having the member ID ‘1075’, pops up and is displayed on the top screen of ‘dwango.co.jp’. Further, when ‘Satomi’ accesses the URL ‘http://www.dwango.co.jp’, the message ‘welcome’ from the user (‘Ponta’) is popped up and displayed on the top screen of ‘dwango.co.jp’.

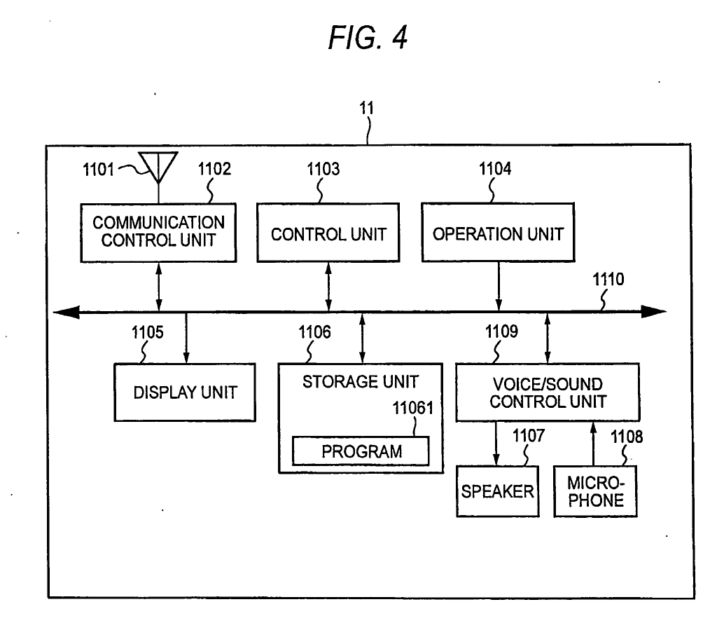

FIG. 4 is a block diagram showing the configuration of the portable terminal 11. In FIG. 4, a portable terminal 11 comprises an antenna 1101, a communication control unit 1102, a control unit 1103, an operation unit 1104, a display unit 1105, a storage unit 1106, and a voice/sound control unit 1109. The communication control unit 1102 is connected to the antenna 1101 and performs communication with the mobile network 13 through the antenna 1101. Through the communication control unit 1102, communication with the web server 12 or voice conversation via telephone can be carried out.

The control unit 1103 comprises a CPU, ROM, RAM and the like and controls the portable terminal 11 in accordance with the program 11061 stored in the storage unit 1106. For example, the web browsing is controlled by various kinds of portable applications, such as JAVA® applications. The control unit 1103 receives inputs from the operation unit 1104, and performs various processing and controls the display in accordance with the processing.

The storage unit 1106 comprises a storing region 11061 for storing the above-mentioned program. The operation unit 1104 comprises keys and/or other input devices for inputting telephone numbers, addresses and the like, and for selecting linked destinations. The display unit 1105 may display a browser or screens for telephone or mail functions. The voice/sound control unit 1109 is connected to a speaker 1107 for outputting a voice or a ring melody and a microphone 1108 for inputting the voice of the user, and performs voice processing upon reception or the transmission of speech.

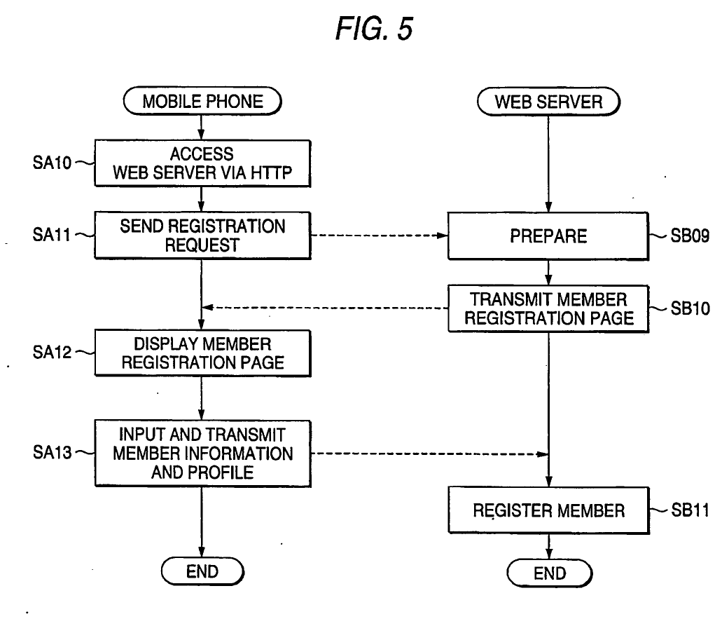

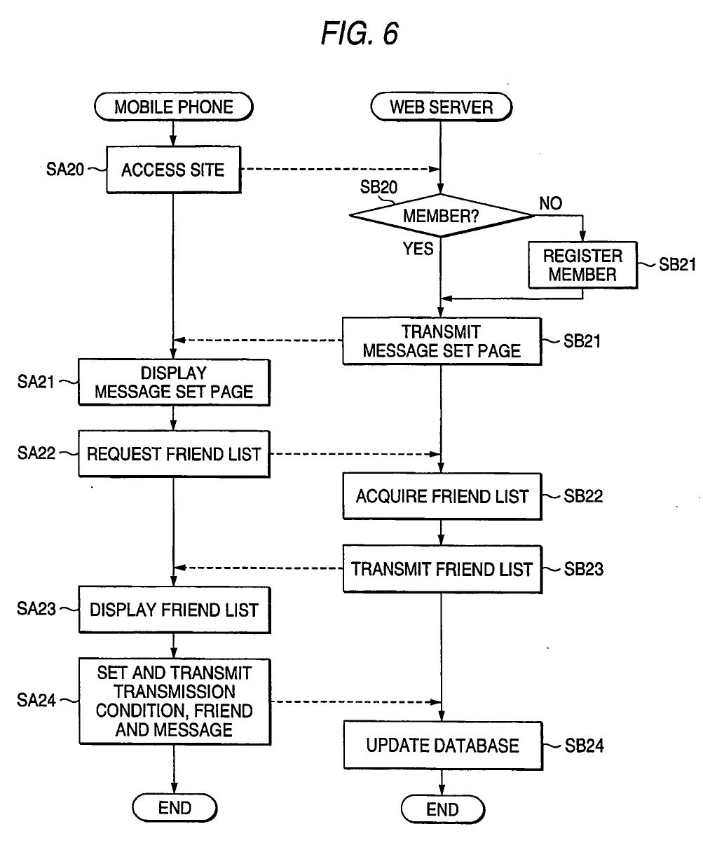

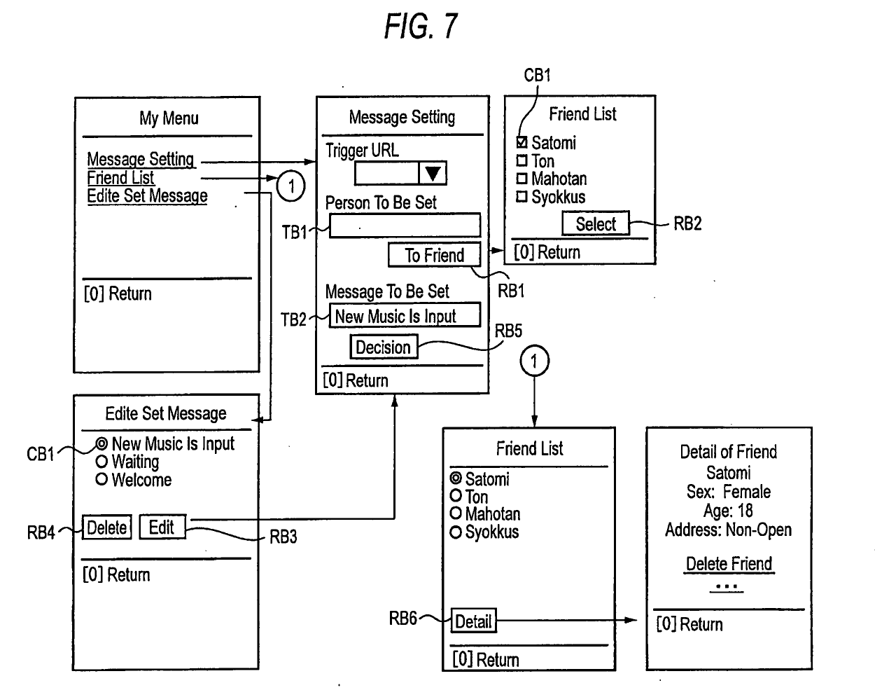

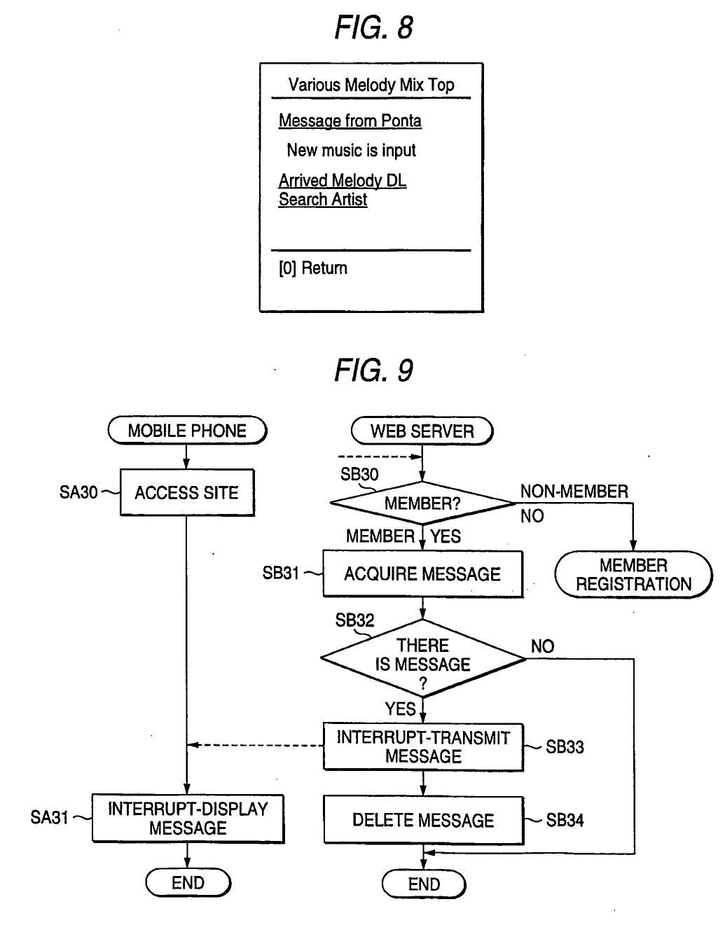

Next, the operation of the portable terminal 11 and the web server 12 having the above-mentioned configuration will be described with reference to the drawings. FIG. 5 is a flowchart for illustrating the operations of the portable terminal 11 and the web server 12 when registering a member, FIG. 6 is a flowchart for illustrating the operations of the portable terminal 11 and the web server 12 when setting a message, FIG. 7 illustrates screen transitions of the portable terminal 11 when setting the message, FIG. 8 illustrates an example of displaying the message, and FIG. 9 is a flowchart illustrating the operations of the portable terminal 11 and the web server 12 when receiving the message.

First, the member registration will be described with reference to FIG. 5. As shown in FIG. 5, when, for example, a JAVA® application in the portable terminal is started by a user, the portable terminal accesses the web server 12 via the mobile network 13 and the Internet 14, using HTTP (step SA10). In step SA11, the portable terminal 11 sends a request to the web serer 12 to register as a member. The web server 12 then prepares a member registration page and transmits it to the portable terminal 11 using HTTP (step SB10). The member registration page transmitted from the web server 12 is displayed on the screen of the portable terminal 11 (step SA12). The user then inputs member information and a profile in the member registration page displayed on the screen of the portable terminal 11.

After the member information and the profile are input by the user, an application, such as a JAVA® application, residing on the portable terminal 11 transmits the member information and the profile input by the user using HTTP (step SA13). The member is then registered in the database 15 based on the profile of the user of the portable terminal 11 (step SB11).

For example, if the user is ‘Ponta’, the ‘memberID’ section is recorded with ‘1001’, the ‘entrance date’ section is recorded with ‘20030912’, the ‘mail address’ section is recorded with ‘PONTA@dwango.ne.jp’, and the ‘name’ section is recorded with ‘Ponta’, in the member record table 151 shown in FIG. 3A. If the user is, for example, ‘Satomi’, the ‘member ID’ section is recorded with ‘1005’, the ‘entrance date’ section is recorded with ‘20030913’, the ‘mail address’ section is recorded with ‘SATOMI@dwango.ne.jp’, and the ‘name’ section is recorded with ‘Satomi’, in the member record table 151 shown in FIG. 3A.

In FIG. 3B, an example of the friend record is shown. For each member, up to four friends can be registered. Here, Ponta, having the member ID ‘1001’, is registered with three friends having the member IDs of 1005, 1075, and 1289. Satomi, having the member ID ‘1005’, is not registered with a friend.

In FIG. 3C, an example of the message record is shown. The message record has a configuration in which a number of messages equal to the number of registered friends can be defined. In other words, here, up to 4 destinations can be set. The friend record and the message record use the same ID. The destination ID shows the member ID of the friend. When the mobile phone of the friend accesses the URL that has been specified as a trigger to transmit the message, the message is sent in accordance with the trigger.

In the member ‘Ponta’, the destination ID of 1005 (Satomi which is the friend) is registered with the message ‘Good afternoon’ and the transmission condition is access to http://www.dwango.co.jp/ABC/. Similarly, the destination ID of 1075 (friend) is registered with the message ‘new music is input’ and the transmission condition is access to http://www.dwango.co.jp/DEF/. In addition, in the content set by the member ‘Satomi’, the destination ID of 1001 (Ponta which is the friend) is registered with the message ‘new music is input’, and the transmission condition is access to http://www.dwango.co.jp/DEF/.

Subsequently, the operation when setting a message will be described with reference to FIG. 6. In FIG. 6, the user of a portable terminal 11 sends a message and accesses the web server 12 (step SA20). At this time, the user's member ID is transmitted. Web server 12, extracts the member ID of the accessing mobile phone 11, refers to the member record table 151 of the database 15, and determines whether or not the user is the member (step SB20).

When the user of the accessing portable terminal is not a member, the member registration page is transmitted and then the member registration process is performed as illustrated in FIG. 5. Then, the process proceeds to step SB21. On the other hand, if the user of the accessing portable terminal is a member, the message set page for transmitting the message to the concerned party is transmitted to the portable terminal 11 (step SB21). On the portable terminal 11, the message set page transmitted from the web server 12 is displayed (step SA21).

Upon setting the message, the friend which receives the message can be set by using the friend list in which the mail address of the friend is already registered (see FIG. 3B). In this case, the portable terminal 11 requests the friend list from the web server 12 (step SA22). When there is a request for the friend list, the friend list corresponding to the requested member is acquired by accessing the friend list record table 151 (step SB22). Thus, the friend list is transmitted to the portable terminal 11 (step SB23) and the friend list is displayed on the screen of the portable terminal 11 (step SA23).

The selection of the page such as the accessed site which becomes the transmission condition (the trigger of the message transmission), the selection of the friend which becomes the message destination and the input of the message are performed by the user of the portable terminal 11 and is transmitted to the web server 12 (step SA24). When the set contents of the transmission condition, the friend and the message from the portable terminal 11 are received by the web server 12, the database 15 is updated with the content (step SB24).

Upon selecting the friend, the friend to which this message is to be transmitted is selected from the friend list displayed on the screen of the portable terminal 11 and is set as the destination of the message. For example, ‘Satomi’ is set as the message destination. After setting the friend, the message is set. For example, the message ‘new music is input’ is set. The web server registers the set message in the message record of the database 15. Thereby, if, for example, the user is ‘Satomi’ and the friend that is this message's destination is ‘Ponta’, the ‘destination’ section of ‘4020’ which is the record of the ‘IDs determined by member ID’ is registered with ‘1001’ which is the member ID of ‘Ponta’, the section of the ‘URL’ is registered with http://www.dwango.co.jp/DEF, and the section of the ‘message’ is registered with ‘new music is input’, as shown in FIG. 3C.

In addition, although the friend to which this message is to be transmitted is set from a ‘friend list’ in the above description, the name of the friend may be directly input as mentioned below. In this case, the step SA22 by the portable terminal 11 and the steps SB22 and SB23 by the web server 12 are omitted.

Next, the screen transition of the portable terminal 11 upon setting the message will be described with reference to FIGS. 7 and 8. If the ‘message setting’ option is selected from the initial screen of the message set page on the portable terminal 11, the ‘message setting’ screen is then displayed on the portable terminal 11.

First, the website for triggering the message transmission is selected. For example, a ring melody distribution web site may be selected. For example, http://www.dwango.co.jp/DEF/, the URL of the ring melody web site, is set as the transmission condition. After the site which becomes the transmission condition is selected, the recipient of the message is set. In this case, the name of the friend to which the message is to be transmitted may be input in the text box TB1, or the name of the friend may be selected from a list by pressing the button RB1 and calling up the friend list.

Here, if the button RB1 (‘to friend’) is pressed in order to call up the friend list, a ‘friend list’ screen is displayed. On the ‘friend list’ screen, the names of the friends which have been previously registered are displayed. In FIG. 7, ‘Satomi’, ‘Ton’, ‘Mahotan’ and ‘Syokkus’ are displayed. Among them, if ‘Satomi’ is selected, the mark is checked in the check box CB1. And, if the button RB2 (‘select’) is pressed, ‘Satomi’ is set. After the friend is set, the user may return to the ‘message setting’ screen by selecting ‘[0] return’. At this time, ‘Satomi’ is displayed in the text box TB1.

After the friend who is the message recipient or destination is set, the message is input in the text box TB2. To edit the input message, the user may return to the ‘My menu’ screen and then select ‘Edit set message’. The display then shows the ‘Edit’ screen and previously input messages are displayed in addition to the newly input message. For example, although ‘new music is input’, ‘waiting’ and ‘welcome’ may be selected in FIG. 7, the message may also be set by directly inputting the characters. Also, on the screen of ‘Edit set message’, it is possible to delete the message, in addition to editing the message. In addition, it is possible to confirm the detail of the friend which is registered in the friend list.

Thus, the message setting is finished, and ‘various melodies’, ‘Satomi’ and ‘new music is input’ are displayed on the screen of ‘message setting’. If it is satisfactory, the button RB5 (‘decision’) is pressed. Thereby, the member ID ‘1001’ of ‘Ponta’ is registered in the section of the destination ID of the ID ‘4020’ of ‘Satomi’ (member ID ‘1005’) of the message record table 153 of the database 15, http://www.dwango.co.jp/DEF/ of ‘various melodies’ is registered in the section of ‘URL’, and ‘new music is input’ is registered in the section of ‘message’.

In addition, when ‘Satomi’ accesses the web server 12 having the URL of ‘various melodies’ using his or her own portable terminal 11, the access to the URL is triggered, the message from ‘Ponta’ is extracted, and the message of ‘new music is input’ is distributed into the portable terminal 11 of ‘Satomi’ and then is displayed on the screen thereof, as illustrated in FIG. 8. The process of acquiring the message will be described below.

Next, the operation upon acquiring the message will be described with reference to FIG. 9. In FIG. 9, first, the site, that is, the web server 12 is accessed by the portable terminal 11 (step SA30). In the case that the member ID is sent from the portable terminal 11 upon accessing the web server 12, whether or not the member ID is member is determined by referring to the member record table 151 of the database 15 (step SB30). In the case that it is not a member, the process proceeds to the member registration process as discussed above. On the other hand, in the case that it is a member, the process of acquiring the message from the message record table 153 is performed (step SB31).

As a result of acquiring the message, whether or not there is a message is determined (step SB32), and, if there is no message, the process is finished. But, if there is a message, the message pops up and is transmitted to the portable terminal 11 through the web (step SB33). Thereby, the message transmitted from the web server 12 pops up and is displayed on the screen of the portable terminal (step SA31). In addition, the transmitted message is deleted from the message record table 153 (step SB34). Alternatively, the transmitted message may be deleted after being confirmed by the user of the portable terminal 11, in addition to automatically deleting the transmitted message by the web server 12. Furthermore, the message may be maintained for a predetermined period (for example, a week) and then may be automatically deleted after the period expires.

Here, if the person accessing the web server 12 is ‘Satomi’, the message from ‘Ponta’ is displayed on the screen of the portable terminal 11 of ‘Satomi’. In other words, as in the display example of FIG. 8, ‘new music is input’ is displayed on top of the screen of ‘various melodies’ as the message from ‘Ponta’.

As mentioned above, according to the present embodiment, by using the location accessed in a virtual world embodied by the network of a portable terminal such as a mobile phone as a trigger, a message can be efficiently communicated.

In addition, by recording the message which is desired to be sent to the friend member correspondingly to the URL of the web server 12, the recorded message is distributed to the mobile phone 11 of the friend when the friend accesses the web server 12 through his/her own mobile phone 11, and thereby the user can receive the message from the friend which knows his/her own favorite music genre or artist when the user wants to download an melody and visits the arrived melody distribution site. In other words, since beneficial information can be exchanged among the members, the communication is activated and thus the usability of the information distribution site can be improved.

Also, although the message pops up and is displayed on the screen of the portable terminal 11 by using HTML in the above-mentioned embodiment, it may be sent to the portable terminal 11 of recipient as an electronic mail. In this case, the mail address of the member record is referred to. Also, the message may be delivered to an application on the portable terminal 11 of the recipient. In this case, after delivering the message, the message is displayed on the screen of the portable terminal 11 when the application is started up. As possible methods for the distribution of the message, there are, for example, (1) pop-up display of the page of the URL, (2) distribution via electronic mail, and (3) distribution to the application of the portable terminal 11.

Further, although characters are used as the distributed message in this example, a voice may be output by the voice synthesis, songs having no lyrics or melody of CD sound source may be output, or image data such as the still image data or dynamic image data which is previously prepared may be output.

The present invention can be applied to a system for distributing a message in mobile communications.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather the present invention extends to all functionally equivalent structures, methods and uses, such as are within the scope of the appended claims.

What is claimed is:

1. A server system for communicating with a portable terminal through a network, comprising:
a message storage for storing a message and address information and associating the message with the address information;
a determiner for determining whether or not a message associated with the address information exists in the message storage when a portable terminal accesses the address information; and
a message transmitter for transmitting the message to the portable terminal if it is determined by the determiner that a message is present.

2. A server system for communicating with a portable terminal through a network, comprising:
a page storage for storing page information and address information and associating the page information with the address information in the network;
a message storage for storing a message and address information and associating the message with the address information in the network;
a page transmitter for reading out the page information associated with the address information from the page storage and transmitting a page image based on the read out page information to the portable terminal, when the portable terminal accesses the address information stored in the page storage through the network;
a determiner for determining whether or not the address information is associated with a message in the message storage when the portable terminal accesses the address information; and
a message transmitter for transmitting the associated message to the portable terminal, wherein the address information is uniform resource locator (URL) information.

3. A server system for communicating with a portable terminal through a network, comprising:
a page storage for storing page information and address information and associating the page information with the address information in the network;
a message storage for storing a message and address information and associating the message with the address information in the network;
a page transmitter for reading out the page information associated with the address information from the page storage and transmitting a page image based on the read out page information to the portable terminal when the portable terminal accesses the address information stored in the page storage through the network;
a determiner for determining whether or not the address information is associated with a message in the message storage when the portable terminal accesses the address information; and
a message transmitter for transmitting the associated message to the portable terminal, wherein the message transmitter allows the message to be displayed on the portable terminal.

4. A server system for communicating with a portable terminal through a network, comprising:
a page storage for storing page information and address information and associating the page information with the address information in the network;
a message storage for storing a message and address information and associating the message with the address information in the network;
a page transmitter for reading out the page information associated with the address information from the page storage and transmitting a page image based on the read out page information to the portable terminal when the portable terminal accesses the address information stored in the page storage through the network;
a determiner for determining whether or not the address information is associated with a message in the message storage when the portable terminal accesses the address information; and
a message transmitter for transmitting the associated message to the portable terminal, wherein the message transmitter transmits the message to the portable terminal in the form of mail.

5. The server system according to claim 4, further comprising:
a member storage for storing member information such as a mail address and corresponding portable terminal identification information; and
a member determiner for determining whether or not the portable terminal is a member based on the portable terminal identification information, by referring to the member storage,
wherein the message transmitter reads out the mail address of the member from the member storage and transmits the message to the read out mail address in the form of mail if it is determined by the member determiner that the portable terminal is a member.

6. A server system for communicating with a portable terminal through a network, comprising:
a page storage for storing page information and address information and associating the page information with the address information in the network;
a message storage for storing a message and address information and associating the message with the address information in the network;
a page transmitter for reading out the page information associated with the address information from the page storage and transmitting a page image based on the read out page information to the portable terminal when the portable terminal accesses the address information stored in the page storage through the network;
a determiner for determining whether or not the address information is associated with a message in the message storage when the portable terminal accesses the address information; and
a message transmitter for transmitting the associated message to the portable terminal, wherein the server system further comprises a register for registering the message stored in the message storage and identification information of the portable terminal which receives the message in the message storage so that the message corresponds to the identification information, in response to the portable terminal accessing the address information.

7. The server system according to claim 6, wherein the register further registers the message correspondingly to the address information.

8. A message communication method for communicating with a portable terminal through a network, comprising:
storing a message and an address information in memory;
associating the message with the address information in the memory;
determining whether or not a message associated with the address information is present in the memory, when a portable terminal accesses the address information; and
transmitting the message to the portable terminal if it is determined that a message is present.

9. A message communication method for communicating with a portable terminal through a network, comprising:
storing page information and address information in memory;
associating the page information with the address information in the memory;
storing a message and an address information in memory;
associating the message with the address information in the memory;
reading out a page information associated with an address information from the memory and transmitting a page image based on the read out page information to a portable terminal, when the portable terminal accesses the address information stored in memory;
determining whether or not the address information is associated with a message in the memory when the portable terminal accesses the address information; and
transmitting the associated message to the portable terminal, wherein the address information is a uniform resource locator (URL) information.

10. A message communication method for communicating with a portable terminal through a network, comprising:
storing page information and address information in memory;
associating the page information with the address information in the memory;
storing a message and an address information in memory;
associating the message with the address information in the memory;
reading out a page information associated with an address information from the memory and transmitting a page image based on the read out page information to a portable terminal, when the portable terminal accesses the address information stored in memory;
determining whether or not the address information is associated with a message in the memory when the portable terminal accesses the address information; and
transmitting the associated message to the portable terminal, wherein the message is displayed on the portable terminal when it accesses the address information.

11. A message communication method for communicating with a portable terminal through a network, comprising:
storing page information and address information in memory;
associating the page information with the address information in the memory;
storing a message and an address information in memory;
associating the message with the address information in the memory;
reading out a page information associated with an address information from the memory and transmitting a page image based on the read out page information to a portable terminal, when the portable terminal accesses the address information stored in memory;
determining whether or not the address information is associated with a message in the memory when the portable terminal accesses the address information; and
transmitting the associated message to the portable terminal, wherein the message is transmitted to the portable terminal in the form of mail.

12. The message communication method according to claim 11, further comprising storing member information such as a mail address and corresponding portable terminal identification information in memory, and determining whether or not the portable terminal is a member based on identification information of the portable terminal, by referring to the memory,
wherein transmitting the message includes reading a mail address of the member from the memory and transmitting the message to the read mail address in the form of mail, if it is determined that the portable terminal corresponds to a member.

13. A message communication method for communicating with a portable terminal through a network, comprising:
storing page information and address information in memory;
associating the page information with the address information in the memory;
storing a message and an address information in memory;
associating the message with the address information in the memory;
reading out a page information associated with an address information from the memory and transmitting a page image based on the read out page information to a portable terminal, when the portable terminal accesses the address information stored in memory;
determining whether or not the address information is associated with a message in the memory when the portable terminal accesses the address information; and
transmitting the associated message to the portable terminal, wherein the message communication method further comprises registering the message stored in the memory and identification information of the portable terminal which receives the message so that the message corresponds to the identification information, in response to the portable terminal accessing the address information.

14. The message communication method according to claim 13, wherein registering the message includes registering the message corresponding to the address information.

15. A program executed by a server for communicating with a portable terminal through a network, the program containing code which when executed by the server causes the server to perform operations comprising:
storing a message and an address information in memory;
associating the message with the address information in the memory;
determining whether or not a message associated with the address information is present in the memory, when a portable terminal accesses the address information; and
transmitting the message to the portable terminal if it is determined that a message is present.

16. A program executed by a server for communicating with a portable terminal through a network, the program containing code which when executed by the server causes the server to perform operations comprising:
storing page information and address information in memory;
associating the page information with the address information in the memory;
storing a message and an address information in memory;
associating the message with the address information in the memory;
reading out a page information associated with an address information from the memory and transmitting a page image based on the read out page information to a portable terminal, when the portable terminal accesses the address information stored in memory;
determining whether or not the address information is associated with a message in the memory when the portable terminal accesses the address information; and
transmitting the associated message to the portable terminal, wherein the address information is a uniform resource locator (URL) information.

17. A program executed by a server for communicating with a portable terminal through a network, the program containing code which when executed by the server causes the server to perform operations comprising:
storing page information and address information in memory;
associating the page information with the address information in the memory;
storing a message and an address information in memory;
associating the message with the address information in the memory;
reading out a page information associated with an address information from the memory and transmitting a page image based on the read out page information to a portable terminal, when the portable terminal accesses the address information stored in memory;
determining whether or not the address information is associated with a message in the memory when the portable terminal accesses the address information; and
transmitting the associated message to the portable terminal, wherein the message is displayed on the portable terminal when it accesses the address information.

18. A program executed by a server for communicating with a portable terminal through a network, the program containing code which when executed by the server causes the server to perform operations comprising:
storing page information and address information in memory;
associating the page information with the address information in the memory;
storing a message and an address information in memory;
associating the message with the address information in the memory;
reading out a page information associated with an address information from the memory and transmitting a page image based on the read out page information to a portable terminal, when the portable terminal accesses the address information stored in memory;
determining whether or not the address information is associated with a message in the memory when the portable terminal accesses the address information; and
transmitting the associated message to the portable terminal, wherein the message is transmitted to the portable terminal in the form of mail.

19. The program according to claim 18, the operations further comprising storing member information such as a mail address and corresponding portable terminal identification information in memory, and determining whether or not the portable terminal is a member based on identification information of the portable terminal, by referring to the memory,
wherein transmitting the message includes reading a mail address of the member from the memory and transmitting the message to the read mail address in the form of mail, if it is determined that the portable terminal corresponds to a member.

20. A program executed by a server for communicating with a portable terminal through a network, the program containing code which when executed by the server causes the server to perform operations comprising:
storing page information and address information in memory;
associating the page information with the address information in the memory;
storing a message and an address information in memory;
associating the message with the address information in the memory;
reading out a page information associated with an address information from the memory and transmitting a page image based on the read out page information to a portable terminal, when the portable terminal accesses the address information stored in memory;
determining whether or not the address information is associated with a message in the memory when the portable terminal accesses the address information; and
transmitting the associated message to the portable terminal, wherein the message communication method further comprises registering the message stored in the memory and identification information of the portable terminal which receives the message so that the message corresponds to the identification information, in response to the portable terminal accessing the address information.

21. The program according to claim 20, wherein registering the message includes registering the message corresponding to the address information.
